(19) United States
(12) Patent Application Publication
(10) Pub. No.: US 2025/0153946 A1
(43) Pub. Date: May 15, 2025

(54) PORT MAGAZINE

(71) Applicant: Autostore Technology AS, Nedre Vats (NO)

(72) Inventor: Kjetil Gilje, Sandeid (NO)

(73) Assignee: AutoStore Technology AS, Nedre Vats (NO)

(21) Appl. No.: 18/715,523

(22) PCT Filed: Dec. 6, 2022
(86) PCT No.: PCT/EP2022/084632

§ 371 Date: May 31, 2024

(30) Foreign Application Priority Data
Dec. 14, 2021 (NO) 20211507

(51) Int. Cl. B65G 1/137; B65G 1/04; B65G 1/06; G06Q 10/08

(52) U.S. Cl. CPC B65G 1/1378; B65G 1/0464; B65G 1/06; G06Q 10/08

(57) ABSTRACT

A buffer system is for delivering containers to and from the station. The storage and retrieval system includes a framework structure which includes a rail system including a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction. The first and second sets of parallel rails divide the rail system into a plurality of grid cells. The framework structure includes upright members defining storage columns for storing containers within the framework structure. The storage and retrieval system includes at least one container handling vehicle configured to operate on the rail system. The buffer system has at least two automated lifts for delivering containers to and from the station. A first lift is for delivering containers to the station that have been delivered from the framework structure by a container handling vehicle and a second lift is for delivering containers from the station to the framework structure of the storage and retrieval system using a container handling vehicle. The speed of the first and the second lifts in the buffer system is controlled with the effect that when one container is finished at the station another is delivered to the station.

### FIELD OF THE INVENTION

The present invention relates to an automated storage and retrieval system for storage and retrieval of containers, in particular to a system and method for buffering containers to and from a picking port.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,301b,201c,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, each rail may comprise two parallel tracks, or the rails in one direction may comprise one track and the rails in the other comprise two parallel tracks. Where a rail comprises two parallel tracks, the rail be formed from two rail members which have been fastened together, each rail member provided with one of the tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

A problem can be that the delivery of bins to the station can cause a buildup of containers on the grid waiting to deliver their containers to the stations. This slows down the grid and causes unnecessary time where the container handling vehicles are not operating at full potential. A reason for this problem is that the people picking at the station picks at various speeds and the container handling vehicles therefor has to wait until the lift transporting the container to the station is free.

It is hence a need for a system wherein the container handling vehicles does not have to spend time waiting to deliver their cargo at the station it is therefore need for a system where there can be a little slack in the system where the container handling vehicles can deliver when they have time without having to wait or holding up the station.

### SUMMARY OF THE INVENTION

The present invention is set forth and characterized in the independent claims, while the dependent claims describe other characteristics of the invention.

In one aspect, the invention is related to a buffer system for a station of a storage and retrieval system, wherein the storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the storage and retrieval system comprises at least one container handling vehicle configured to operate on the rail system, wherein the buffer system has at least two automated lifts for delivering containers to and from the station, wherein a first lift is for delivering containers to the station that have been delivered from the framework structure by a container handling vehicle and a second lift is for delivering containers from the station to the framework structure of the storage and retrieval system using a container handling vehicle.

Further, the speed of the first and the second lifts in the buffer system can be controlled by that when one container is finished at the station another is delivered to the station and the operator at the station controls when a container is ready for delivering back into the framework structure of the storage and retrieval system.

Also, the first and second lifts in the buffer system each comprise a belt or chain in the form of a loop and the belt can be provided with a plurality of shelves and each shelf can be in the form of a block, the shelves can each be hinged at least in one place.

The containers can be held in place in the first and/or second lift by the belt or belts being pushed towards a side of the respective container. The outer belts at a pick-up point and/or delivering point for a container in the first lift or the second lift can be hinged in order to allow the containers to enter or exit the lift at the correct place. The container is held in place in the first lift or the second lift by a mechanical guide that guides spring loaded shelves into the right position.

The present invention also encompasses a port comprising columns of a storage and retrieval system which are occupied with the above described buffer system and linked together with the station as a unit. The port may be configured to fit into an existing storage and retrieval system as a retrofit.

In a second aspect, the invention concerns a storage and retrieval system comprising a framework structure, a container handling vehicle, a station and a buffer system as claimed in any preceding claim for delivering containers to and from the station.

In a third aspect the invention is directed to a method of using a buffer system at a station of a storage and retrieval system, wherein the storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the storage and retrieval system comprises at least one container handling vehicle configured to operate on the rail system, wherein the method includes picking up a first container from the framework structure of the storage and retrieval system using a container handling vehicle, loading the first container into a first lift of the buffer system that delivers containers to the station, transporting the first container to the station using the first lift of the buffer system, picking the required items from the first container at the station, transporting the first container into a second lift of the buffer system that delivers containers back into the framework structure of the storage and retrieval system, delivering a new, second container for picking from the first lift of the buffer system to the station delivering the second container back into the framework structure of the storage and retrieval system using a container handling vehicle when the second container is at the top of the second lift of the buffer system.

When one container is transported out of the station to the second lift of the buffer system, another container is transported into the station by the first lift of the buffer system.

This solution allows the picker at the station to control the speed of the picking and the buffer system allows the container handling vehicles to load the buffer system like a magazine, which allows the container handling vehicles to operate on the grid with as little as possible time spent waiting for delivering or picking up the containers from the station. The container handling vehicles can deliver the containers from the storage and retrieval system when it is placed in the buffer system and not when the lift is ready, because by being able to load the lifts with multiple containers like a magazine, this gives the container handling vehicles more freedom when delivering their containers.

### BRIEF DESCRIPTION OF THE DRAWINGS

Following drawings are appended to facilitate the understanding of the invention. The drawings show embodiments of the invention, which will now be described in greater detail by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective frog view of an internal cavity solution wherein the lifting platform is on its way down.

FIG. 5a-c is a side view of the buffer system wherein both the elevator bringing the containers from the storage and retrieval system to the station and the elevator bringing the container from the station back to the storage and retrieval system are displayed.

FIG. 6 is a side view of an embodiment of the present invention which illustrates synchronized belt movement, as well as how the bins are supported and how the elevators can bring the containers between the storage and retrieval system and the station.

FIG. 7 is a side view of fixed, hinged or multi hinged blocks 602 for transporting containers between the grid of the storage and retrieval system and the station. This allows for a more compact solution as the shelf length is reduced when the block is on the outside of the lifts.

FIG. 8 is a top view of an embodiment of the present invention wherein the two elevators are placed behind each other in relation to the station.

FIG. 9 is a top view of an embodiment of the present invention wherein the lifts are placed next to each other. Further, it is displayed how a hinged separate lower «belt grip» that would open for arm rotation, and close to grip the bin and lift it in/out of the magazine.

FIG. 10 is a side view of a belt grip that holds a bin by friction according to the embodiment presented in FIG. 9, this solution pushing a belt towards the containers.

FIG. 11 displays motorized wheel/roller grip which holds bins by friction and pushes wheels/rollers towards bin to get grip.

FIG. 12 is an alternative solution using pin-shelf which are shelfs hidden inside belt/chain drive in return direction, and mechanically ejected when in lift side.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

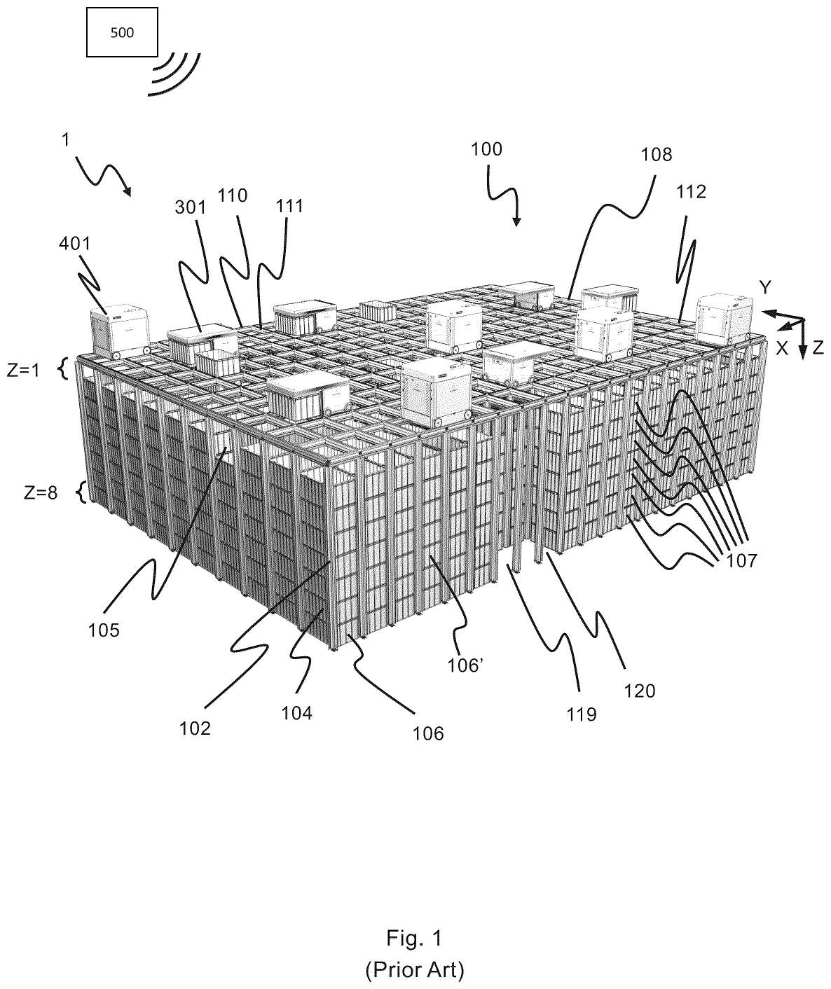

The framework structure 100 of the automated storage and retrieval system 1 is constructed in accordance with the prior art framework structure 100 described above in connection with FIGS. 1, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

The present invention concerns a system and a method relating to a buffer system for a station 701.

One of the more uncertain factors of the automated warehouse system in an automated storage and retrieval system is the operator/picking speed, i.e., the time used per container, as this can be unpredictable. The system needs to be in standby/idle for as small an amount of time as possible and for each operator/port instead to be doing preparations and other tasks to keep the general count of pick per hour as high as possible, based on the operator. To reduce the idle time of the container handling vehicle on top of ports to deliver/pick up containers, an automated buffer may be provided with up to 10+ containers and preferably with 2-5 containers, that can feed/pick up containers just-in-time for the port/operator, whilst the container handling vehicle can deliver/pick up containers in the buffer only when signalized a waiting port task, and then go back to other tasks quickly afterwards.

Through such a buffer system, this could reduce idle time of the container handling vehicle and potential time the operator waits for the container handling vehicle and the container. As a side bonus the port interaction operation will go faster for the container handling vehicle, due to reduced lifting height. In short: the container handling vehicle will only interact with the magazine, instead of the operator. The magazine will keep the operator busy based on the operator pace.

In short, the present invention is a synchronized two sided lift system with a belt or chain or similar being used to provide such a lift system and through the provision of one buffer for container delivery and one buffer for container return on the port.

The benefit is a higher container throughput, due to better utilization of the time of the container handling vehicle. (less idle time on port, more prep time) and less waiting on action from the container handling vehicles for the operator, as the port magazine keeps the container closer to the port at any time, compared to a robot 20 lowering gripper from top of the grid.

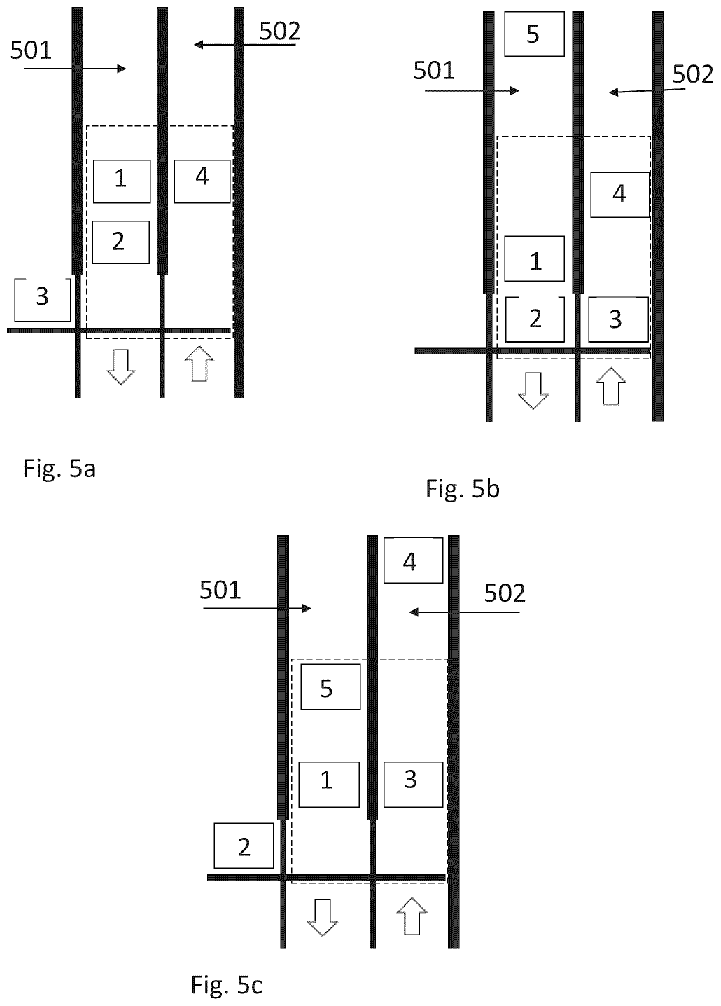

Embodiments of the automated storage and retrieval system according to the invention will now be discussed in more detail with reference to FIGS. 5a-12.

FIG. 5a-c is a side view of the buffer system wherein both the elevator bringing the containers from the storage and retrieval system to the station 701 and the elevator bringing the container from the station 701 back to the storage and retrieval system is displayed.

In FIG. 5 we can see that the buffer system is comprised of a first lift 501 bringing containers from the storage and retrieval system to the station 701 and a second lift 502 bringing the containers from the station 701 to the storage and retrieval system.

A first container 1 is transported from the framework structure of the storage and retrieval system using a container handling vehicle.

The first container 1 is placed into the first lift 501 of the buffer system and transported from the grid level of the storage and retrieval system and down to the level of the station 701 by the first lift 501. When it is at the level of the station 701 the container is transported to the station 701 using e.g. a conveyor belt. When it is at the station 701 the operator picks the required items from the container and when finished the container is sent back to the buffer system. The second lift 502 transports the container from the level of the station 701 to the grid level of the storage and retrieval system.

When the first container is transported from the station 701 to the second lift 502, a second container is transported from the first lift 501 to the station 701.

Both the first 501 and the second lift 502 have the capability to store more than one container. The buffer system acts like a magazine where it is possible to store the containers as they are waiting to be picked or to be placed back into the storage and retrieval system. Each lift in the storage system has the capability to store a plurality of containers. The number of containers that can be placed in the buffer system depends on the difference in height between the top of the grid and the level of the station 701. Assuming that the station 701 is placed on the floor level, the number of containers in each lift might be more than five and even up to 10+.

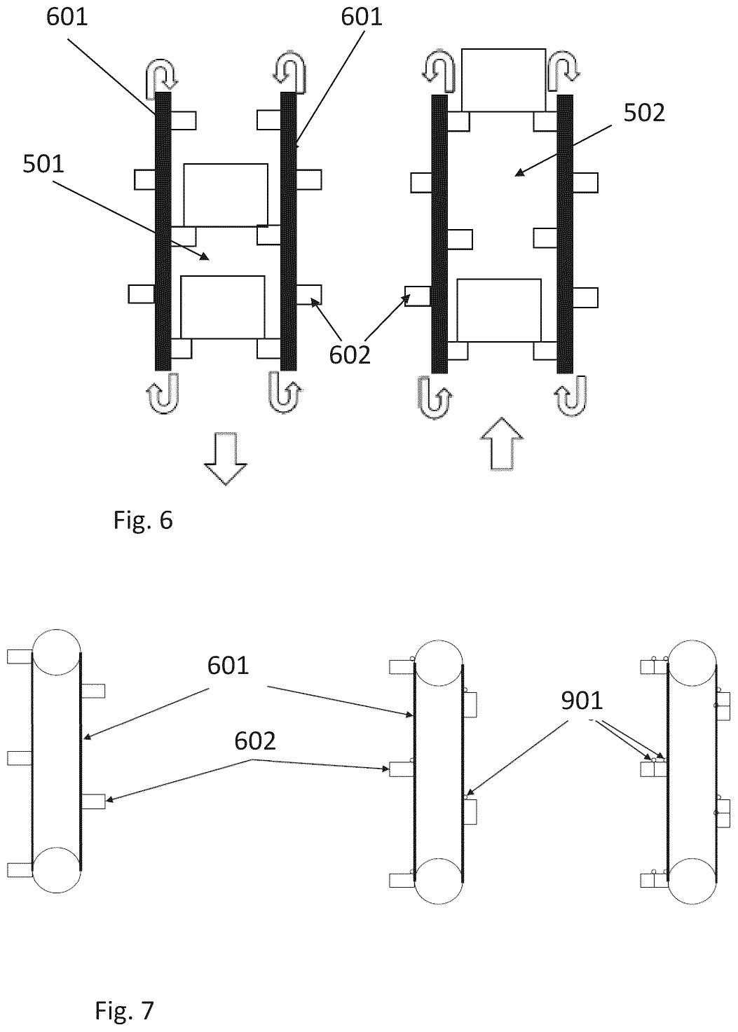

FIG. 6 is a side view of an embodiment of the present invention wherein it is displayed synchronized belt 601 movement and how the bins are supported and how the elevators can bring the containers between the storage and retrieval system and the station 701.

In this embodiment it is shown how each lift may be comprised of two belts 601 running from the top of the storage and retrieval system and to the level of the station 701. The belts 601 of either lift system are spaced apart in order to accommodate a container between them. The belts 601 are hence placed on opposing sides of the containers.

Either of the belts 601 can be in the form of a belt 601 looped around an electric motor in one end and a roller in the other end. Alternatively, there can be an electric motor in either end. The electric motor can turn the belt around and around. As mentioned earlier one lift is comprised of two belts 601. In order for the lift to work the belts 601 needs to be counter rotating. Further the movement of the belts 601 need to be synchronized. This means that either belt 601 moves the same amount of rotations of the electric motor. Hence the movement of all the electric motors in one lift need to be synchronized in order for safe transportation of the containers to and from the station 701.

The belts 601 on either side of the lift that transports the containers from the grid of the storage and retrieval system and to the station 701, hence downwards, needs to rotate towards each other at the top and away from each other at the bottom. The belts 601 on either side of the lift that transports the containers from the station 701 and towards the grid of the storage and retrieval system needs to rotate away from each other at the top and towards each other at the bottom.

In this embodiment the belts 601 on either side of either lift have blocks 602 attached to them at regular intervals pointing outwards. The blocks 602 on both belts 601 of a lift are opposed and oppositely directed each other. This allows the containers to rest on the blocks 602, like a shelf system, while they are being transported between the grid of the storage and retrieval system and the station 701.

Other arrangements are also envisaged, for example, where a single belt is used which supports the storage containers between collection from/return to the container handling vehicle and dropping off with/collection from the station.

FIG. 7 is a side view of fixed, hinged or multi hinged blocks 602 for transporting containers between the grid of the storage and retrieval system and the station 701. This allows for a more compact solution as the shelf length is reduced when the block 602 is on the outside of the lifts.

As the belts 601 go around and around the blocks 602 are only useful when they are pointed towards each other (that is to say either lifting or lowering the containers). When the blocks 602 are pointing away from each other (that is to say not either lifting or lowering the containers), the blocks 602 take up an unnecessary amount of space if they are standing straight out. It is therefore a benefit if the blocks 602 could fold down when they are not in use. An easy way of doing this is to let the blocks 602 be hinged 901 one way so that when they are carrying a container they are pointing straight out, and when they are on the outside of the lift, they fold and lie flat along with the belt 601.

In an alternative solution, the blocks 602 can be multi hinged 901. This means that there is more than one hinged 901 joint per block 602, and all the hinges 901 are hinged the same way. This allows for a smoother transition from standing straight out to lying flat against the belt 601. A further benefit of a multi hinged 901 solution is that the blocks 602 need less space as they are either folding out or folding in.

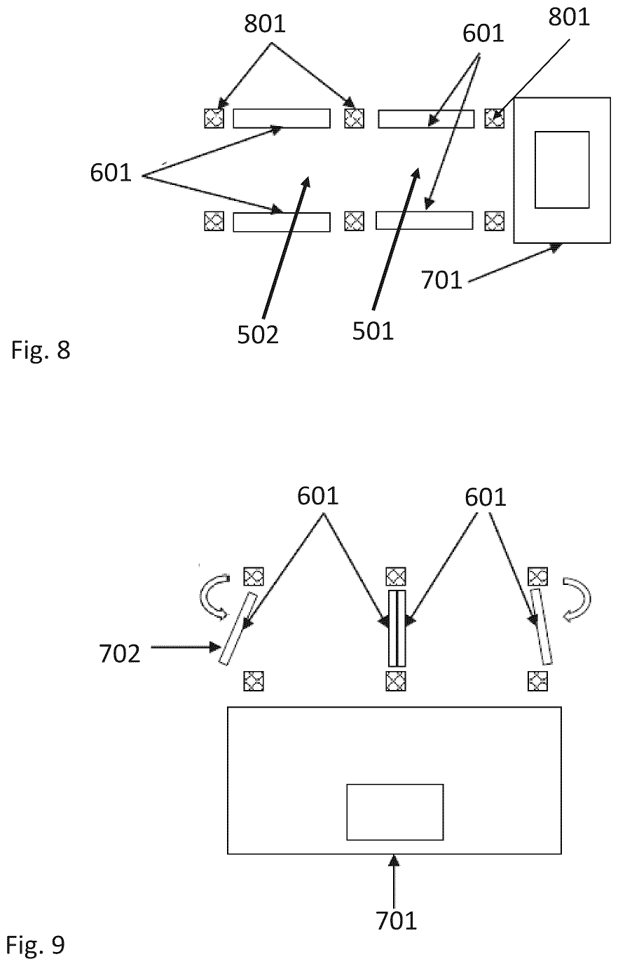

FIG. 8 is a top view of an embodiment of the present invention wherein the two elevators are placed behind each other in relation to the station 701. This solution is optimal for a station 701 where the containers are delivered to the station 701 from the lift system via conveyor belts 601.

The image displays a solution where the station 701, is placed to the far right of the drawing. Immediately to the left of the station 701 there is a pair of upright members 801. These members 801 acts as a fixing point for the electric motors and/or the rollers at either end of the belt 601 loops 601.

The conveyor system allows for the container to pass through a first lift 501 to the second lift 502 behind it.

FIG. 9 is a top view of an embodiment of the present invention wherein the lifts are placed next to each other. Further, it is displayed how a hinged separate lower «belt 601 grip» that would open for arm rotation, and close to grip the bin and lift it in/out of the magazine.

In this embodiment of the present invention the lifts are placed next to each other. This solution is best suited for a station 701 that uses a carousel solution for presenting the containers to the operator. In this embodiment the central belt 601 can used for both lifts since one lift brings the containers downwards and the other brings the containers upwards and the two lifts are synchronized. Hence, the shelfs or the blocks 602 function as resting points for containers going both up and down.

Further as it is illustrated in this drawing the electric motor and/or the rollers of the outer most belts 601 can be hinged 702 at either end so as to be able to allow the belt 601 to grip around the sides of the container. The gripping motion creates friction between the belt 601 and the container, and the container is held in place as it is transported either up or down in the lift.

Although this solution is presented only in this drawing this gripping of the belts 601 in order to create enough friction between the container and the belt 601 in order to be able to transport the container either up or down in the lifts can be implemented in the other embodiments of the present invention.

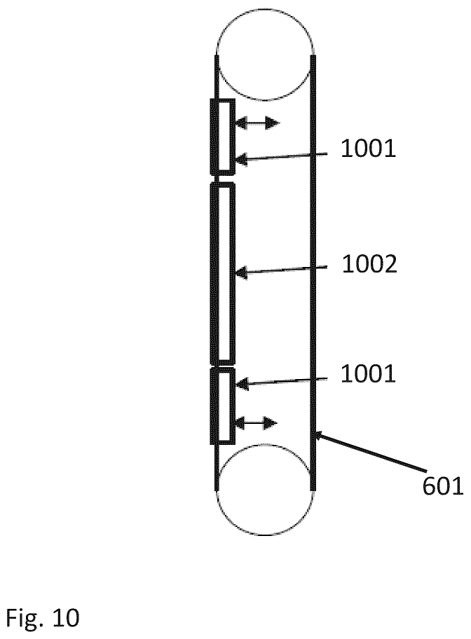

FIG. 10 is a side view of a belt 601 grip that holds containers by friction according to the embodiment presented in FIG. 9, this solution pushes the belts 601 towards the containers. Here we can see a looped belt 601 stretched around an electric motor and/or a roller. The belt 601 symbolizes one of two belts 601 of a lift. As illustrated here the belt 601 is pushed towards the container holding it in place by friction. The pushing of the belt 601 onto the container can be done by clamps. In this embodiment there are three clamps that push the belt onto the container. There is a grip and release clamp 1001 at either end and a fixed middle clamp 1002 between the two grip and release clamp 1001s. The grip and release clamp 1001 at either end allow for gripping and releasing the container as it is either loaded onto the lift or off the lift. The fixed middle clamp 1002 holds the container in please during the transportation phase between each end point.

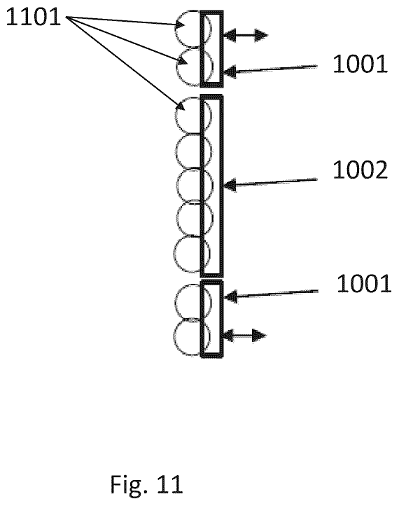

FIG. 11 displays an embodiment of the embodiment presented in FIG. 10. Here it is displayed a method for motorized wheels or roller grip which holds containers in place when they are in the lifts by friction and pushes the wheels or the rollers towards the containers in order to get grip. Like the embodiment presented in FIG. 10 the clamping solution is comprised of a gripping and releasing clamp at either end and a fixed middle clamp 1002 between the gripping and releasing clamps 1001. The force with which the gripping and releasing clamps 1001 are pushed against the side of the container can be controlled by a motorized set of wheels. These motorized wheels can be spring loaded in order to be able to follow the contours of the sides of the containers as they are transported through the lifts.

The fixed middle clamps 1002 cannot be moved so as to adjust the amount of force used for pushing the wheels or rollers against the containers. However, the wheels or roller grips that is used for pushing the middle clamp 1002 against the containers can be spring loaded in order to make it possible for the clamp to follow the contours of the containers as they pass by the clamp.

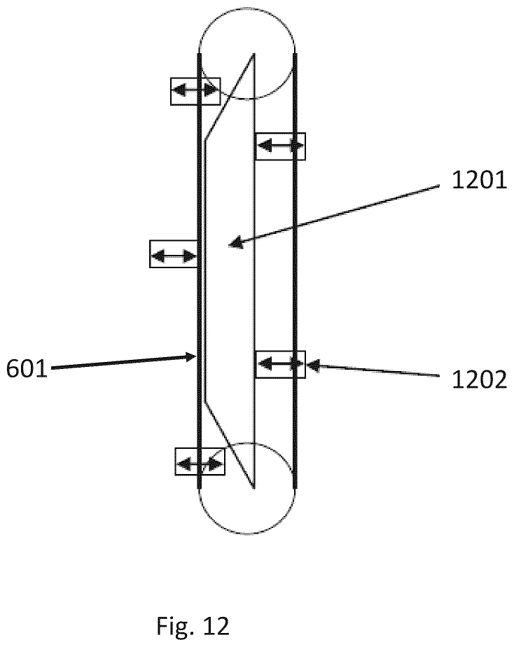

FIG. 12 is an alternative solution using pin-shelves 1202 which are shelves 1202 hidden inside belt 601 when driven in a return direction, and mechanically ejected when on the lift side. In this solution the containers are placed on shelves 1202 as they are transported between the station 701 and the grid top of the storage and retrieval system. Here we can see a looped belt 601 stretched around an electric motor and/or a roller. The belt 601 symbolizes one of two belts 601 of a lift. The shelves 1202 in the belt 601 can be pushed in and out by a mechanical guide 1201. The mechanical guide 1201 ejects the shelves 1202 from holes in the belts 601 and they are spring loaded so that they retract in when the guide is not actively pushing them out.

In the preceding description, various aspects of the delivery vehicle and the automated storage and retrieval system according to the invention have been described with reference to the illustrative embodiment. For purposes of explanation, specific numbers, systems, and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

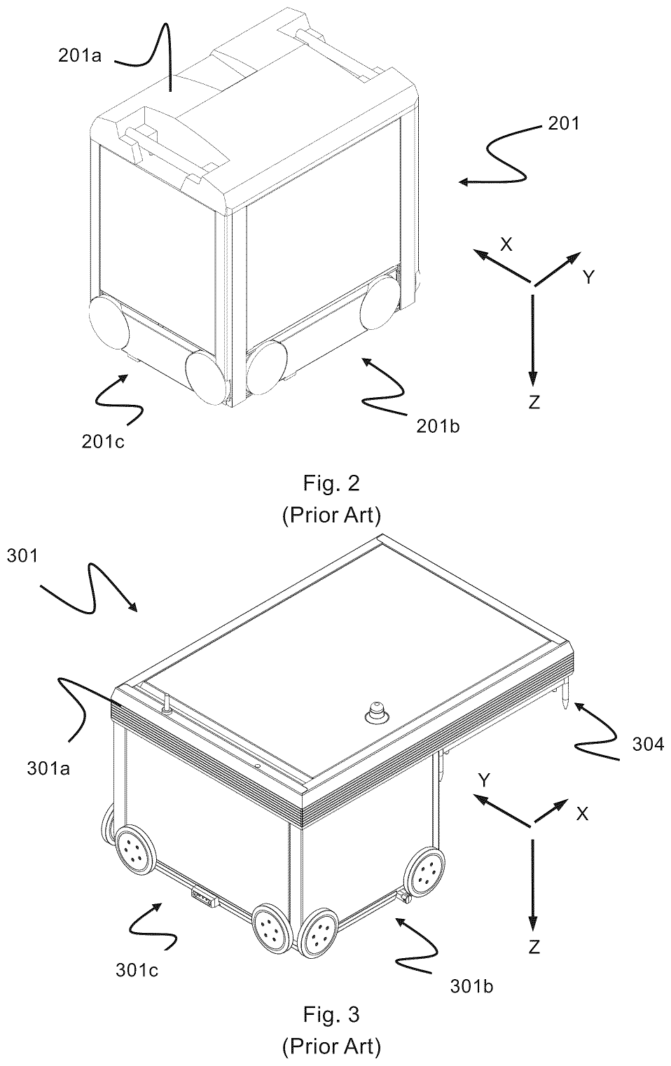

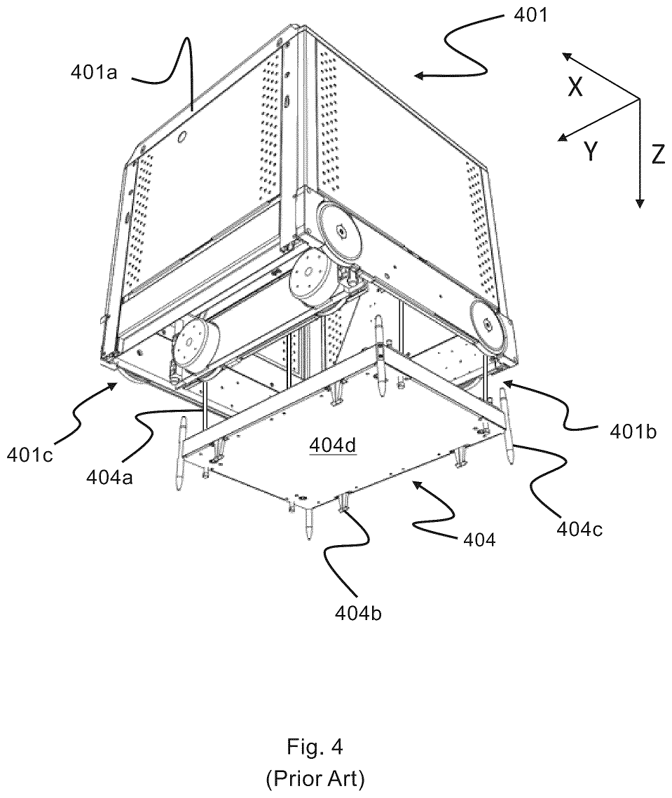

### Prior Art (FIGS. 1-4)

1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
501 First lift (Delivery lift/buffer system)
502 Second lift (Retrieval lift/buffer system)
601 Synchronized belts for lift/buffer system
602 Blocks for holding containers in lift/buffer system
701 Station
702 Hinged lower part of the lift/buffer system
801 Upright members (lift system)
901 Hinge for blocks
1001 Grip/release clamp
1002 Fixed middle clamp
1101 Motorized wheel/roller grip
1201 Mechanical guide 1201
1202 Shelf part.
X First direction
Y Second direction
Z Third direction

1. A buffer system for a station of a storage and retrieval system,
wherein the storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction,
the first and second sets of parallel rails dividing the rail system into a plurality of grid cells, the framework structure comprising upright members defining storage columns for storing containers within the framework structure,
wherein the storage and retrieval system comprises at least one container handling vehicle configured to operate on the rail system,
wherein the buffer system has at least two automated lifts for delivering containers to and from the station,
wherein a first lift is for delivering containers to the station that have been delivered from the framework structure by a container handling vehicle and a second lift is for delivering containers from the station to the framework structure of the storage and retrieval system using a container handling vehicle, and
wherein the speed of the first and the second lifts in the buffer system is controlled with the effect that when one container is finished at the station another is delivered to the station.

2. The system according to claim 1, wherein the operator at the station controls when a container is ready for delivering back into the framework structure of the storage and retrieval system.

3. The system according to claim 1, wherein each automated lift for delivering containers to and from the station can have up to 10 storage containers each.

4. The system according to claim 1, wherein each automated lift for delivering containers to and from the station preferably has 1-4 containers.

5. The system according to claim 1, wherein the first and second lift in the buffer system each comprise a belt or chain in the form of a loop and the belt is provided with a plurality of shelves.

6. The system according to claim 5, wherein each shelf is in the form of a block.

7. The system according to claim 1, wherein the blocks are each hinged at least in one place.

8. The system according to claim 1, wherein the containers are held in place in the first and/or second lift by the belt or belts being pushed towards a side of the respective container.

9. The system according to claim 8, wherein outer belts at a pick-up point and/or delivering point for a container in the first lift or the second lift is/are hinged in order to allow the containers to enter or exit the lift at the correct place.

10. The system according to claim 1, wherein a container is held in place in the first lift or the second lift by a mechanical guide that guides spring loaded shelves into the out position.

11. A storage and retrieval system comprising a framework structure, a container handling vehicle, a station, and a buffer system claim for delivering containers to and from the station,
wherein the storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction,
the first and second sets of parallel rails dividing the rail system into a plurality of grid cells, the framework structure comprising upright members defining storage columns for storing containers within the framework structure,
wherein the storage and retrieval system comprises at least one container handling vehicle configured to operate on the rail system,
wherein the buffer system has at least two automated lifts for delivering containers to and from the station,
wherein a first lift is for delivering containers to the station that have been delivered from the framework structure by a container handling vehicle and a second lift is for delivering containers from the station to the framework structure of the storage and retrieval system using a container handling vehicle, and
wherein the speed of the first and the second lifts in the buffer system is controlled with the effect that when one container is finished at the station another is delivered to the station.

12. A method of using a buffer system at a station (701) of a storage and retrieval system, wherein the storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction,
the first and second sets of parallel rails dividing the rail system into a plurality of grid cells, the framework structure comprising upright members defining storage columns for storing containers within the framework structure,
wherein the buffer system has at least two automated lifts for delivering containers to and from the station,
wherein a first lift is for delivering containers to the station that have been delivered from the framework structure by a container handling vehicle and a second lift is for delivering containers from the station to the framework structure of the storage and retrieval system using a container handling vehicle, and
wherein the speed of the first and the second lifts in the buffer system is controlled with the effect that when one container is finished at the station another is delivered to the station,
wherein the storage and retrieval system comprises at least one container handling vehicle configured to operate on the rail system, wherein the method includes:
picking up a first container from the framework structure of the storage and retrieval system using a container handling vehicle,
loading the first container into a first lift of the buffer system that delivers containers to the station.
transporting the first container to the station using the first lift of the buffer system,
picking the required items from the first container at the station,
transporting the first container into a second lift of the buffer system that delivers containers back into the framework structure of the storage and retrieval system,
delivering a new, second container for picking from the first lift of the buffer system to the station, and
delivering the second container back into the framework structure of the storage and retrieval system using a container handling vehicle when the second container is at the top of the second lift of the buffer system.

13. The method according to claim 12, wherein when one container is transported out of the station to the second lift of the buffer system, another container is transported into the station by the first lift of the buffer system.
